(19) United States
(12) Patent Application Publication
(10) Pub. No.: US 2013/0053594 A1
(43) Pub. Date: Feb. 28, 2013

(54) METHODS OF MAKING SELF-HEALING POLYMER AND GEL COMPOSITIONS

(71) Applicants: Ka Yee Christina Lee, Chicago, IL (US); Niels Holten-Andersen, Chicago, IL (US); J. Herbert Waite, Santa Barbara, CA (US)

(72) Inventors: Ka Yee Christina Lee, Chicago, IL (US); Niels Holten-Andersen, Chicago, IL (US); J. Herbert Waite, Santa Barbara, CA (US)

(73) Assignee: The University of Chicago, Chicago, IL (US)

(21) Appl. No.: 13/516,079

(22) PCT Filed: Dec. 17, 2010
(86) PCT No.: PCT/US10/61154

§ 371 Date: Aug. 27, 2012

Related U.S. Application Data
(60) Provisional application No. 61/284,472, filed on Dec. 17, 2009.

(51) Int. Cl. C07F 15/02; C07F 7/28; C07F 5/06

(52) U.S. Cl. 556/56; 556/150; 556/179

(57) ABSTRACT

Methods for making self-healing polymer and gel compositions with crosslinks comprising coordinate bonds between monomer subunits and metals are disclosed.

### RELATED APPLICATIONS

This application claims priority to U.S. Provisional Patent Application Ser. No. 61/284,472 filed Dec. 17, 2010, which is herein incorporated by reference in its entirety.

This invention was made with government support under grants DMR-0820054 and MCB-0920316 awarded by the National Science Foundation, and grant number R01-DE018468 awarded by the National Institutes of Health. The government has certain rights in the invention.

### BACKGROUND OF THE INVENTION

The present invention provides for methods of making self-healing polymer and gel compositions capable of cross-linking with coordinate bonds between monomer subunits and metals and those compositions.

Growing evidence supports a structural role of metal-polymer interactions in biological protein scaffolds. In particular, the strength of the coordinate bonds in metal-ligand coordination complexes combined with their capacity to reform after breaking has been proposed as a source of the high toughness and potential self-healing in certain natural materials.

Some of the highest, known stabilities among metal-ligand coordination complexes are found between Fe³⁺ and catechol ligands at alkaline pH where the tris-catecholato-Fe³⁺ stoichiometry prevails (log KS≈37-40). Several studies have tested the mechanical properties of solid-state materials cross-linked with catechol-Fe³⁺ complexes. Due to the low solubility of Fe³⁺ at high pH (basic conditions), however, these studies have been performed at low pH (acidic conditions) or at Fe:catechol ratios greater than ⅓ where mono-catecholato-Fe³⁺ complexes are favored. Hence, the effect of tris-catecholato-Fe³⁺ cross-links on material properties has not been characterized. Moreover, the properties of polymers having metal-ligand coordinate cross-linking have also not been characterized.

Materials undergoing physical stress in a variety of contexts such as handling mechanical loads fail because the stress disrupts the intermolecular bonds of the material. Such stress is manifested in the form of cracks in the material. Materials that are capable of spontaneously repairing themselves would be well-suited for applications where materials are needed to endure such stresses.

There is, therefore, a growing demand for self-healing bioadhesives and coatings, such as self-healing polymer materials, that can be easily delivered and that solidify in situ to form strong and durable interfacial adhesive bonds and are resistant to the normally detrimental effects of water. Some of the potential applications for such biomaterials include consumer adhesives, bandage adhesives, tissue adhesives, bonding agents for implants, drug delivery. It is also preferable to prepare these adhesives in a toxicologically acceptable solvent that enables injection to the desired site and permits a conformal matching of the desired geometry at the application site.

### SUMMARY OF THE INVENTION

In one aspect, methods for forming self-healing polymers are disclosed, which include providing a polymer having at least two catechol groups; contacting the polymer with a solution comprising a soluble metal of formula Mⁿ⁺ at a first pH value where n is an integer of from 1 to 9; and contacting the polymer metal solution with another solution to achieve a second pH value, wherein the second pH value is higher than the first pH value.

In some embodiments, the metal is selected from iron, aluminum, titanium, vanadium, manganese, copper, chromium, magnesium, calcium, and silicon.

In some embodiments, the polymer backbone is selected from polyethylene glycol, polyacrylate, polymethacrylate, polystyrene, polyvinyl polymer, and polypeptide.

In some embodiments, the metal is coordinated to at least two catechol groups at the second pH value. In some embodiments, the metal is coordinated to three catechol groups at the second pH value. In some embodiments, the polymer metal solution with another solution to achieve a third pH value, wherein the third pH value is higher than the first and second pH values.

In some embodiments, the polymer includes a second monomer (a copolymer). In some embodiments, the second monomer includes a catechol group.

In some embodiments, n is 3. In some embodiments, the metal is iron and the monomer is dopa.

In some embodiments, the catechol to metal ratio is no less than 3:1.In some embodiments, the catechol to metal ratio is about 3:1.

In some embodiments, the polymer is a synthetic polymer. In some embodiments, the polymer is a non-peptide polymer. In some embodiments, the polymer comprises a backbone of polyethylene glycol.

In another aspect, polymer compositions prepared by the methods described above are disclosed.

### BRIEF DESCRIPTION OF THE DRAWINGS

FIG. 1A shows a diagram of a PEG-Dopa₄ solution with Fe³⁺ at pH 3, according to one embodiment.

FIG. 1B shows a diagram of a PEG-Dopa₄ gel with Fe³⁺ at pH 12, according to one embodiment.

FIG. 1C shows the UV-Vis spectra of a PEG-Dopa₄ with Fe³⁺ solution before (mono-complex) and a gel after addition of base to pH 12(tris-complex).

FIG. 1D shows a diagram of PEG-Dopa₄ solution before addition of (IO₄)⁻.

FIG. 1E shows a diagram of PEG-Dopa₄ solution after addition of (IO₄)⁻.

FIG. 1F shows the UV-Vis spectra of the covalently cross-linked PEG-Dopa₄ gel after addition of (IO₄)⁻.

FIG. 1G is a diagram showing rheological data (G′) collected from a sample of PEG-Dopa₄ gel with Fe³⁺ at pH 12 and PEG-Dopa₄ gel after addition of (IO₄)⁻.

FIG. 2A shows the Raman spectra of PEG-Dopa₄ with Fe³⁺ at varying pH.

FIG. 2B is a plot showing the calculated fraction of complexes in mono-, bis-, and tris-catechol-Fe³⁺ complexes as a function of pH based on the UV-Vis data shown in FIG. 2C.

FIG. 2C shows the Uv-Vis absorption spectra of the PEG-Dopa₄-catechol-Fe³⁺ gel at different pH values spanning pH 3 to pH 10.

FIG. 3A shows the frequency sweep of PEG-dopa₄ Fe-gels (dopa:Fe molar ratio of 3:1) adjusted to pH values of about 5, pH about 8, and about pH 12, where triangle labels at pH 12 and pH 8 correspond to loss modulus (G″), and circle labels at pH 12 and pH 8 correspond to storage modulus (G′).

FIG. 3B compares the rheological properties of the PEG-dopa₄-Fe³⁺ gel with the covalently cross-linked gel made from PEG-dopa₄-Fe³⁺ and (IO₄)⁻.

FIG. 3C shows rheological recovery data (G′) collected after shear strain induced failure of the covalently and coordinate cross-linked gels (PEG-Dopa₄-catechol-Fe³⁺ at pH 12 and PEG-Dopa₄-catechol oxidized with (IO₄)⁻).

FIG. 3D shows rheological creep data collected from the response of the coordinate cross-linked gel and covalent linked cross-linked gels (PEG-Dopa₄-catechol-Fe³⁺ at pH 12 and PEG-Dopa₄-catechol-Fe³⁺ oxidized with (IO₄)⁻) to constant shear stress.

FIG. 4A is pictures of the physical states of the PEG-dopa₄ Fe-gels at pH values of about 5, about 8, and about 12.

FIG. 4B is pictures showing self-healing properties over a period of 3 minutes of the PEG-dopa₄ Fe-gels prepared from a pH of about 12.

FIG. 4C is pictures showing a lack of self-healing properties of the PEG-dopa₄ gels oxidized with IO₄⁻ over a 12 hour period.

FIG. 5 is pictures of the physical properties of the PEG-dopa₄ Fe-gels and the PEG-dopa₄⁻ gels oxidized by (IO₄)⁻.

FIG. 6A is a data plot of rheological creep data collected from the response of the coordinate cross-linked gels of Al³⁺, Fe³⁺, Ti³⁺, the covalent cross-linked gels, and the uncross-linked gels (PEG-Dopa₄-catechol-metal at pH 12 and PEG-Dopa₄-catechol oxidized with (IO₄)⁻) to constant shear stress.

FIG. 6B shows the frequency sweep of PEG-dopa₄-metal-gels (dopa:metal molar ratio of 3:1) adjusted to pH values of about pH 12, where open labels correspond to loss modulus (G″), and closed labels correspond to storage modulus (G′).

### DETAILED DESCRIPTION

While the terminology used in this application is standard within the art, the following definitions of certain terms are provided to assure clarity.

Units, prefixes, and symbols may be denoted in their International System of Units (SI) accepted form. Numeric ranges recited herein are inclusive of the numbers defining the range and include and are supportive of each integer within the defined range. Unless otherwise noted, the terms “a” or “an” are to be construed as meaning “at least one of.” The section headings used herein are for organizational purposes only and are not to be construed as limiting the subject matter described. All documents, or portions of documents, cited in this application, including but not limited to patents, patent applications, articles, books, and treatises, are hereby expressly incorporated by reference in their entirety for any purpose.

As used herein, the term “self-healing” refers to a property of a material that can undergo spontaneous repair. In some examples, self-healing results in restoration of a material to its original chemical structure. In some examples, self-healing results in restoration of a material to nearly its original chemical structure such as reforming at least three or more coordinate bonds. For example, a self-healing polymer can have coordinate bonds between a metal and one or more ligands from monomer subunits of the polymer. Those coordinate bonds can break from external force, but the coordinate bonds can spontaneously reform.

It should be understood, therefore, that self-healing polymers described herein differ from polymers and gels which have cross-linking from covalent bonding as those compositions lack coordinate bonding between monomers and a metal.

As used herein, the terms “complex” and “chelate” may be used interchangeably to refer to chemical interactions of atoms through coordinate bonding.

As used herein, the terms “coordinate bonding” and “coordinate bonds” refer to the chemical bonding of coordination complexes. Coordinate complexes involve bonding between two atoms in which both electrons shared in a bond come from the same atom. The atom or chemical group which has an electron pair to share is referred to as the ligand. A metal represents the other atom to which the electrons are shared from the ligand. One or more ligands may coordinate with a metal. Coordinate bonding, therefore, is different from covalent bonding where the electrons in a bond between two atoms come from both the atoms.

It should be appreciated that as used in the art, the term “ligand” may refer to a single chemical group such as a hydroxyl as a ligand, and may refer to a molecule having multiple chemical groups such as catechol as a ligand. As used herein, the term “ligand” may refer to a molecule having one or more chemical groups capable of engaging in a coordinate bond or the chemical group itself.

As used herein, the terms “synthetic polymer” and “synthetic gel” refer to a non-naturally occurring polymer.

As used herein, the terms “non-peptide polymer” and “non-peptide gel” refer to polymers and gels which do not have a peptide backbone.

We demonstrate here that a concentrated solution of a simple polymer modified with catechol and mixed with Fe3+ at a Fe:catechol ratio of ⅓ at a pH value of about 3, spontaneously gels via tris-catecholato-Fe3+ cross-linking upon increasing basicity to a pH value of about 9. The resulting gels have strengths comparable to covalently cross-linked gels (about 103-104 Pa) as well as the capacity to self-heal. We conclude that tris-catecholato-Fe3+ cross-links impart unprecedented viscoelastic properties to the established gels.

A novel method to control catechol-metal inter-polymer cross-linking via pH has been developed. The resonance Raman signature of catechol-metal (such as catechol-Fe3+) cross-linked gels at high pH was similar to that from native mussel thread cuticle and the polymer gels displayed elastic moduli (G′) that approach covalently cross-linked gels (about 103 Pa) and self-healing properties (complete recovery of G′ after shear-induced failure).

In one aspect, self-healing polymer gel compositions are disclosed. The polymer compositions include at least one monomer subunit and metal capable of coordinating with a functional group of a monomer. In some embodiments, the self-healing polymer or gel is derived from a synthetic polymer or synthetic gel. In some embodiments, the self-healing polymer or gel is derived from a non-peptide polymer or non-peptide gel.

Suitable monomers include monomers with functional groups that may function as ligands of metals in coordination complexes. In some embodiments, a first monomer subunit includes a catechol functional group. Catechol functional groups are characterized by having two hydroxyl groups at adjacent positions on a phenyl ring. In some embodiments, the catechol group is attached to a polymer backbone at one position, and the two hydroxyl groups are located ortho- and meta- thereto. In some embodiments, the catechol group is attached to a polymer backbone at one position, and the two hydroxyl groups are located meta- and para- thereto.

Examples of such monomers include monomers with one or more catechol groups. For example, the amino acid dopa (3,4-dihydroxyphenylalanine) has an amino acid backbone that is functionalized with a catechol group. In another example, dihydroxyhydrocinnamic acid may serve as a monomer which possesses a catechol group. In some embodiments, the polymer backbone is selected from polyethylene glycol, polyacrylate, polymethacrylate, polystyrene, polyvinyl polymer, and polypeptide. In some embodiments, the polymer backbone is selected from polyethylene glycol, polyacrylate, polymethacrylate, polystyrene, and polyvinyl polymer.

Other metal-complexing polymers based on monomers and copolymers may be used such as those described in U.S. patent application Ser. Nos. 11/834,651, 12/568,527, 12/624,285, 12/568,542, 12/239,787 and 12/099,254 (the latter application published as U.S. 2008/0247984 A1), International patent applications PCT/US2008/083311, published as WO 2009/09460, PCT/KR2008/003130, published as WO 2008/150101, PCT/EP2009/055960, published as WO 2009/147007, and U.S. Pat. Nos. 4,698,171 and 6,506,577, all of which are hereby incorporated by reference in their entirety.

In some embodiments, the polymer is a homopolymer. For example, the polymer may be a homopolymer with polyethylene glycol (PEG) as the backbone. Other hydrophilic polymer backbones may be used in place of the PEG backbone, for example, any polymer that permits water permeation, does not react with Fe3+, and includes one or more catechol moieties connected to the backbone.

In some embodiments, the polymer is a copolymer where at least two different monomers are present. In some embodiments, the monomer has at least one catechol group and the comonomer does not have a catechol group. In some embodiments, the monomer has at least one catechol group and the comonomer has a catechol group.

Examples of catechol-containing polymers that can be used include vinyl addition polymers, such as copolymers of styrene and 3,4-dihydroxystyrene monomers, or styrene and 4-methyltetra(ethylene glycol)benzylstyrene. Further examples include polymers prepared by the copolymerization, and, as will be apparent to one skilled in the art, when necessary, deprotection, of monomers such as acrylic acid, methacrylic acid, 4-vinylbenzoic acid or 4-vinylpyridine and protected catechols, such as 3,4-methylenedioxybenzylacrylate, 3,4-methylenedioxyphenyl-4′-styrylketone, 3,4-methylenedioxyphenyl-4′-styrylcarbinol, or 3,4-diacetoxyphenylvinylketone. Further examples include catechol-containing polymers such as 3,4-dihydroxyphenylvinylketone, all as, for example, described in U.S. Pat. No. 4,698,171, herein incorporated by reference in its entirety. Further examples include catechol-containing copolypeptides such as copolypeptides of L-lysine and L-DOPA containing different compositions of the two monomers prepared using art accepted procedures, with other examples of copolypeptides as further described in U.S. Pat. No. 6,506,577, herein incorporated by reference in its entirety. Further examples include copolymers of L-DOPA with L-glutamic acid, L-serine, and L-alanine Copolypeptides can also be prepared, as described in U.S. Pat. No. 6,506,577, through copolymerization of a-amino acid N-carboxy anhydrides, such as Ne-carbobenzyloxy-L-lysine N-carboxyanhydride and O,O′-dicarbobenzoxy-L-DOPA N-carboxyanhydride, followed by deprotection of the resulting protected copolymer. Further examples include catechol-containing dendritic polymers prepared using condensation polymerization, for example using monomers such as 3,4-dihydroxycinnamic acid and 4-hydroxycinnamic acid to give terminal catechol units. Further examples include poly(ethyleneglycol) (PEG) derivatives such as those described in U.S. patent application Ser. No. 12/099,254, herein incorporated by reference in its entirety. Further examples include catechol-containing PEG-based polymer starting from a amino-capped four-armed 10,000 molecular weight PEG undergoing a nucleophilic ring-opening of di-acetyl-DOPA-N-carboxyanhydride as described in U.S. patent application Ser. No. 12/099,254. Further examples are disclosed in U.S. Pat. No. 7,732,539, herein incorporated by reference in its entirety, which describes polymers with an anionically polymerized block copolymer of methyl methacrylate-methacrylic acid-methyl methacrylate (MMA-MAA-MMA), reacting with 3,4-dihydroxyphenyl alanine to functionalize the polymer with pendant catechol groups. It will be apparent to one skilled in the art that other hydrophilic and/or water-soluble catechol-containing polymers with polymeric backbones that do not interfere with the catechol metal-coordination chemistry may also be used.

Suitable metals that may be used include metals that can engage in coordinate bonding. Examples of suitable metals include those which can have more than one oxidation state. In some embodiments, the metal of the self-healing polymer is a transition metal. In some embodiments, the metal of the self-healing polymer is selected from iron, aluminum, vanadium, titanium, manganese, copper, chromium, calcium, magnesium, and silicon. In some embodiments, the metal is selected from metals which have a high affinity for coordinate binding to 3,4-dihydroxyphenylalanine. In some embodiments, the metal is selected from metals which have a high affinity for coordinate bonding to dihydroxybenzene derivatives. In some embodiments, the metal is ionic, that is, it does not form a covalent bond with a carbon atom such as would be present in a bond between a platinum atom and a phenyl derivative.

In some embodiments, PEG-dopa can bound to a variety of metals. For example, in some embodiments PEG-dopa polymers can be coordinately bound to iron. In some embodiments, PEG-dopa polymers can be coordinately bound to titanium (such as Ti3+). In some embodiments, PEG-dopa polymers can be coordinately bound to aluminum (such as Al3+). In some embodiments, PEG-dopa polymers can be coordinately bound to chromium (such as Cr3+). In some embodiments, PEG-dopa polymers can be coordinately bound to calcium (such as Ca2+). In some embodiments, PEG-dopa polymers can be coordinately bound to magnesium (such as Mg2+). The selection of metal can impart different visco-elastic properties to the resulting self-healing polymer or gel compositions. For example, Ti3+-PEG-dopa produced a stiffer gel, whereas Al3+-PEG-dopa produced a more viscous gel, at the same metal wt %. Other multivalent metals, multivalent cations, or nanoparticles may be used to cross-link, for example, dopa polymers.

The metal may be added to a polymeric material to form the self-healing polymer composition using a variety of metal sources such as metal salts. A variety of counterions may be used with the metal cation, including, but not limited to, chloride, other halides, and nitrate.

The mechanical properties of a self-healing polymer may be controlled by the degree of cross-linking Cross-linking may be controlled by managing the number of molar equivalents of the metal to ligands available from monomers in the polymer. Cross-linking may also be controlled by managing the number of molar equivalents of base (such as NaOH) added to a composition of the metal and polymer to obtain coordination that favors mono-, bis-, and tris-complexation.

In some embodiments, the degree of cross-linking of the self-healing polymer composition may be controlled by varying the metal to catechol ratio. This may be done to vary, for example, the polymer gels' mechanical properties. The metal to ligand ratio may be adjusted, for example, increased or decreased, to yield concentration-dependent cross-linking For example, if the metal is Fe3+, Fe3+ favors hexavalent coordinate complexes, and the ratio of iron to, for example, a bidentate ligand, such as catechol, can be 1:3 under certain conditions, such as high pH. Higher ratios of Fe3+ to ligand may be used if conditions prohibit stoichiometric coordination of Fe3+ to the ligands, and if the prohibition may be solved by changing the concentration of Fe3+. If conditions do not prohibit stoichiometric coordination of Fe3+ to the ligands, then higher ratios of Fe3+ to ligand may result in a higher number of mono- or bis-Fe3+-catechol complexes because a larger fraction of the catechols are bound to an Fe3+ and are unavailable to form cross-links. Lower ratios of Fe3+ to ligand can be used to favor formation of fewer tris-catecholato-Fe3+ complexes or to favor formation of a higher ratio of bis- to tris-catecholato-Fe3+ complexes. The metal to ligand ratio may also be varied in accordance with the preferred metal:ligand stoichiometry. For example, if a metal favors tetravalent complexes, then the metal:ligand ratio would be 1:4 (or 1:2 for bidentate ligands). If a metal favors octavalent complexes, then the metal:ligand ratio would be 1:8 (or 1:4 for bidentate ligands). The preferred metal:ligand stoichiometry in a coordination complex will depend on the electronic configuration of the metal and the identity of the metal.

In some embodiments, the amount of base added, which ultimately determines the final pH, the equilibrium concentrations of the deprotonated ligands, and the equilibrium concentrations of all potential coordination complexes, may also be used to alter the polymer gels' properties. In some embodiments, the number of molar equivalents of base added to make the self-healing polymer can be at least two times the number of monomeric bidentate ligands that may stably coordinate to the metal. In some embodiments, the number of molar equivalents of base added to make the self-healing polymer can be at least 4 times the number of monomeric bidentate ligands that may stably coordinate to the metal.

In one example using PEG-dopa4 polymer, the polymer includes 1 catechol (dopa) moiety covalently linked to each of the PEG arms (in one example, about 60 ethylene glycol units per arm), for a total of 4 dopa units per polymer. The number of dopa moieties per polymer may be varied, for example, increased or decreased. Each catechol moiety can coordinate to Fe3+ in a bidentate fashion through two deprotonated hydroxyls in each catechol group. The Fe3+ center may coordinate to 1, 2, or 3 catechols through the corresponding 2, 4, or 6 such deprotonated hydroxyl groups. The extent of Fe3+-mediated cross-linking may be adjusted by varying several parameters, for example, the molar ratio of metal to dopa, or the moles of base (for example, hydroxide) added to deprotonate the catechol hydroxyl groups.

In another aspect, methods for making self-healing polymers are disclosed. The methods involve providing a polymer which has at least two monomer subunits. The polymer is contacted with a solution having a metal of formula Mn+ at a first pH value. Functional groups, like catechol, in the monomer may then react with the metal to form a mono-complex. Base is added to raise the pH to a second value. Functional groups, like catechol, from other monomer subunits may also react with the metal to form bis- and tris-complexes. In some embodiments, the pH is raised by adding caustic solution prepared from alkali metal hydroxide or alkaline earth hydroxide. In some embodiments, the pH is raised by injecting the polymeric solution with metal into a tissue or aqueous environment such as sea water which has a higher pH.

The metal-ligand complex stoichiometry (mono-, bis- or tris-complex) is controlled by adjusting the pH environment of the composition. At more acidic pH values, the metal will be more soluble in solution, but fewer deprotonated ligands are available at low pH for engaging in coordinate bonds. At more caustic pH values, a higher concentration of deprotonated ligands will be available for engaging in coordinate bonds. The pH value required to establish bis and tris metal-ligand complexes will vary depending on the chemical environment of the polymer, for example, the polymer backbone, the presence of other monomer units in the backbone (whether ligand or non-ligand monomer units), the chemical structure of the ligand, and additional substituents in solution, but may typically be between a pH value of about 5.6 and 14.

When the metal-ligand complex involves cross-linking two ligands in intermolecular cross-linking, the complex cross-links the polymers through a coordinate bond. Thus, in contrast to polymers with metal-ligand complexes that involve only one ligand and polymers with intramolecular cross-linking, intermolecular cross-linking of polymers results in improved material properties.

Without wishing to be bound to any particular theory, when coordinate bonds are broken in the disclosed self-healing polymer compositions, such that the metal has only one coordinate bond with a ligand, the self-healing polymer undergoes repair by formation of an intermolecular coordinate bond with another ligand.

In some embodiments, the amount of cross-linking through coordinate bonding between a metal and ligands from monomers of the polymer is affected by controlling the number of molar equivalents of metal available with the number of ligands available from the monomers.

In some embodiments, the amount of cross-linking through coordinate bonding between a metal and ligands from monomers of the polymer is controlled by the final pH of the solution. The final pH of the solution may be determined, for example, by the number of moles of base added. The final pH of the solution may be determined, for example, by the pH of a solution into which the low pH polymer metal solution is introduced. For example, a low pH solution comprising a polymer and a metal may be introduced to one or more surfaces in an aqueous environment with a higher pH, such as under water, as in the ocean, or in the body, to induce the formation of cross-linked polymers for a particular purpose.

In some embodiments, the molar ratio of metal to ligand is 1:2. In some embodiments, the molar ratio of metal to ligand is 1:3. In some embodiments, the molar ratio of metal to ligand is 1:4.

In some embodiments, the interaction between a metal and monomers with catechol groups of a self-healing polymer are represented in the mono-, bis-, and tris-complexes shown in Scheme I below. It should be appreciated that more than one complex can be present in a polymer matrix, depending upon the pH and molar ratio of metal to ligand. Moreover, when a metal is bound to two or three catechol groups, it is not intended to convey that all available metal is necessarily bound in the same way as an equilibrium of complexes exist as function of the pH and molar ratio of the metal to ligand.

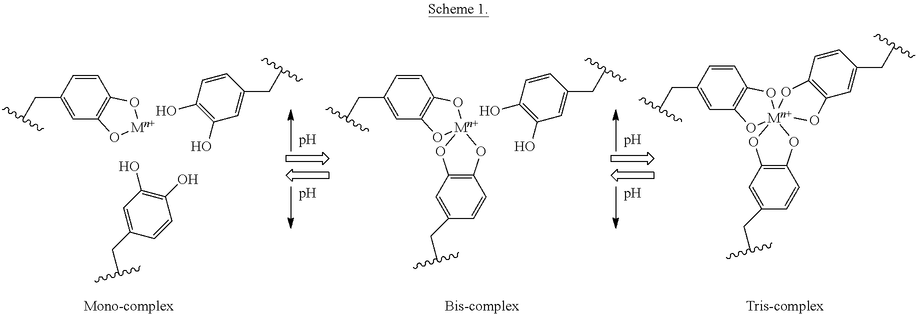

In the mono-complex, the molar ratio of metal to ligand is 1:3, however, the mono-complex is not cross-linked because the metal is only coordinately bound to one ligand. In the bis-complex, the molar ratio of metal to ligand is 1:3. This bis-complex is cross-linked via coordinate bonding between the metal and two ligands. In the tris-complex, the molar ratio of metal to ligand is 1:3, and the tris complex is cross-linked via coordinate binding between the metal and three ligands. In these exemplary representations, each catechol is referred to as a ligand, and one of ordinary skill would recognize that each phenolic hydroxyl of the catechol could be considered a ligand with the coordinating metal.

The value of n in the formula Mn+ for the metal may be an integer from 1 to 9. In some embodiments, n is an integer of from 1 to 7. In some embodiments, n is an integer of from 1 to 5. In some embodiments, n is an integer of from 1 to 4. In some embodiments, n is an integer of from 1 to 3. In some embodiments, n is an integer of from 1 to 2. In some embodiments, n is an integer of from 2 to 5. In some embodiments, n is an integer of from 2 to 4. In some embodiments, n is an integer of from 2 to 3.

The first pH value is selected so that the metal in soluble form may interact with functional groups in a monomer subunit. For example, when the monomer is dopa and the metal is Fe3+, a mono-dopa-Fe3+ complex was attained when the metal was added at a pH value of about 5 or less. Upon addition of about two molar equivalents of base (sodium hydroxide, for example), two phenolic hydroxyls of a second monomeric dopa group are deprotonated and coordinately bind to the pre-bound iron cation, concomitantly bringing the pH value to about 8. The result is polymer cross-linked in a bis-complex. Addition of about two more molar equivalents of alkali, two more phenolic hydroxyls of a third monomeric dopa group are deprotonated and coordinately bind to the pre-bound metal cation. This brings the pH value to about 12 and results in a tris-complex. The molar ratio of metal (a multivalent cation, for example) to dopa may vary according to the valency of the metal. It will be apparent to one skilled in the art that the other ligands and other metals, or the same metals in alternative oxidation states can be matched through knowledge of the coordination chemistry, such as can be found in L. G. Sillén and A. E. Martell, Stability Constants of Metal-Iion Complexes (London: Chemical Society, Special Publications No. 17 and 25, 1964 and 1971); or the NIST Standard Reference Database 46; Critically Selected Stability Constants of Metal Complexes.

In some embodiments, the degree of cross-linking (also called cross-linking density) may be controlled by the metal:ligand ratio. In some embodiments, the degree of cross-linking may be controlled by the metal:catechol ratio. For M3+, the metal:catechol ratio may be varied between 1:2 and 1:30, where a 1:2 ratio results in predominance of bis-catechol-metal cross-links. At higher ratios of between 1:3 and 1:30, predominance of the tris-catechol-metal cross-links may be obtained. The concentration of bis-catechol-metal and tris-catechol-metal in a polymer gel affects the mechanoresponsive properties of a gel.

The concentration of polymer can be varied between about 5 wt % and about 50 wt %. In some embodiments, the concentration of the polymer is between about 5% and about 20%. The concentration may be varied to affect a polymer gel's mechanical properties.

In some embodiments, the monomers of a polymer may be cross-linked with both covalent and coordinate bonds. The addition of covalent cross-links can result in tougher elastic gels. A system containing cross-links based on bimetallic palladium cross-linking of a polymer containing side chain pyridines as well as covalent cross-links is described in Kersey F R, Loveless D M, Craig S L (2007). Varghese, et al., in Journal of Polymer Science Part A: Polymer Chemistry 44, 1, pg 666, describe a hybrid system containing a covalently cross-linked gel based on acryloyl-6-amino caproic acid that is further cross-linked via copper complexes. A simple oxidizer such as NaIO4 can be used to establish a covalently cross-linked gel containing catechols. For example, NaIO4 may be introduced at a concentration of between 1 and 20 mM to form covalent cross-linking bonds between monomers and comonomers. The resulting gel can then be infused with metal cations at low pH (below 5.6 for example), before raising the pH value to between 5.6 and 14 to obtain bis- or tris-catechol-metal cross-links. The coordination cross-links toughen the material by incorporating energy dissipating reversible cross-links throughout an elastic polymer network.

As another example, a polymer may be cross-linked with both covalent and coordinate bonds by first pre-binding a metal by mixing the metal and the polymer at a first pH, at which the metal is soluble, then adding sufficient base and NaIO4 or other oxidizing agent, followed by mixing. This addition would both raise the pH to introduce coordinate cross-links and permit introduction of covalent cross-links.

In some embodiments, water resistant properties may be imparted to a gel material by inclusion of different amounts of amphipathic molecules. The amphipathic molecules may include, for example fatty acids such as n-hexanoic acid, palmitic acid and other fatty acids as well as phopholipids. The amphipathic molecules may be added to the polymer prior to pH-induced gelation (addition of alkali to raise the pH). Fatty acids, for example can decrease the hydration of a polymer matrix and confer water-resistance. Amphipathic molecules can also decrease the dielectric constant of a polymer matrix, which in turn increases the strength of the metal-catechol coordination bonds. In some embodiments, the metal-catechol cross-links can be established by addition of a metal followed by alkali, replacing the aqueous solvent with an organic solvent via dehydration exchange, and then by adding different amounts of amphipathic molecules to the organic solvent-infused polymer gel.

In some embodiments, additional components may be incorporated into a self-healing polymer or gel. The components may be covalently linked to the polymer or included as a non-covalent mixture. For example, antioxidants may be included to protect catechol from oxidation. Suitable antioxidants include but are not limited to, water-soluble antioxidants such as ascorbic acid, glutathione, mycothiol, trypanothione, ubiquinone, uric acid, lipoic acid, carotene derivatives, such as derivatives of vitamin A, water-soluble derivatives of tocopherols, such as trolox, Also suitable are polyphenolic antioxidants, such as resveratrol. Also suitable are synthetic antioxidants, such as propyl gallate (PG, E310), tertiary butylhydroquinone (TBHQ), butylated hydroxyanisole (BHA, E320) and butylated hydroxytoluene (BHT, E321). Also suitable are lipid-soluble antioxidants, such as tocopherols and tocotrienols (vitamin E) which form a family of structurally related antioxidants, as is known in the art.

In some embodiments, oxidants such as IO4—may be incorporated to modulate oxidation of a polymer, such as a polymer comprising both covalent and coordinative cross-links.

In some embodiments, monomers may include functional groups that have polar, non-polar, or both types of groups by covalent linkage. Examples include ambifunctional polymers. In some embodiments, non-covalent components may be mixed with the polymer that separate into a different phase to form domains within a gel matrix. Ambifunctional moieties may also assist in excluding water from penetrating a gel, making a more effective coating such as an anti-fouling coating. Other additives such as anti-microbial and anti-fouling additives may be incorporated to increase the resistance of the polymer to microbial contact.

Aside from bulk mechanical properties of the self-healing polymers and gels described, it should be appreciated that these materials also have useful adhesive properties.

In one aspect, solid state materials with multihydroxyphenyl derivatives cross-linked with metals are disclosed. In another aspect, solid state materials with catechol groups cross-linked with metals are disclosed. In another aspect, solid state materials with dopa groups cross-linked with metals are disclosed.

In one aspect, a self-healing polymer is disclosed comprising a polymer backbone (sometimes abbreviated as “pB”) having attached, generally pendant, dihydroxyphenyl or multihydroxyphenyl derivatives (sometimes abbreviated as “MHPDs”) to form a MHPD-modified polymer (sometimes abbreviated as MHPp). The MHPD groups can be cross-linked by coordinate bonding to a metal. The MHPD-modified polymer may have a variable concentration, distribution, or number of MHPD moieties, which account for about 1 to about 100% by weight MHPp. In some embodiments, the MHPD present accounts for about 1 to about 75% by weight of the MHP-modified polymer. In some embodiments, the MHPD-modified polymer has a total molecular weight between about 1,000 and about 5,000,000 Da.

Self-healing polymers disclosed herein can be used for several applications including, but not limited to, bioadhesives, coatings, underwater coatings, and underwater coatings with antifouling capabilities. Self-healing polymers are useful for these applications because they can be easily delivered and solidify in situ to form strong and durable interfacial adhesive bonds that are resistant to the detrimental effects of water. Additional applications include consumer adhesives, bandage adhesives, tissue adhesives, bonding agents for implants, and materials for drug delivery.

Mussel byssal threads are protected against wear by an outer proteinaceous coating that, despite a hardness of about 0.1 GPa, is capable of accommodating large cyclic strains in the more compliant fibrous core. During strain the coating has been observed to suppress macroscale failure through microscale dissipation of microscopic tears. The coating over mussel byssal threads contains low amounts of iron, and it is proposed to play an important role in this damage dispersing mechanism through its coordination with the iron-binding catechol-like amino acid dihydroxy-phenylalanine (dopa) in the coating protein (mfp-1).

Tris-catecholato-Fe3+ chelates possess some of the highest known stability constants of transition metal-ligand complexes. Single molecule tensile tests have previously demonstrated that the breaking of this metal-dopa bond requires a force, about 0.8 nN at pH 8, which is comparable to covalent bonds in strength (about 2 nN). In contrast to covalent bonds however, Fe3+-dopa bonds spontaneously reform after breaking, and this reversibility has led to speculation that the damaged coating potentially self-heals via remaking of the Fe3+-dopa bonds. We here show that cross-linking a dopa-rich polymer matrix with tris-catecholato-Fe3+ complexes results in a strong and self-healing material.

For example, a polymeric material made from polyethylene glycol with terminal BOC-dopa residues of Formula I (hereinafter referred to as PEG-dopa4) may used to prepare self-healing polymers or gels. The Boc group is not essential to the formation of metal-catecholato coordination complexes, but is a component of the backbone polymer. The Boc group may, therefore, be replaced or modified as described above by other suitable groups to tune the polymer properties.

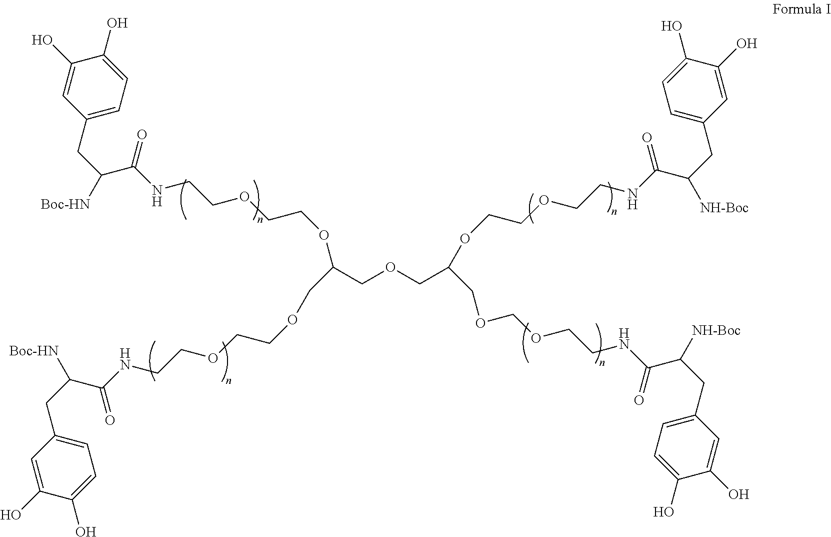

The Fe³⁺-catechol complex stoichiometry (mono-, bis- or tris-catechol-Fe³⁺) may be controlled by pH via the deprotonation of the catechol hydroxyls, as displayed in Scheme II below.

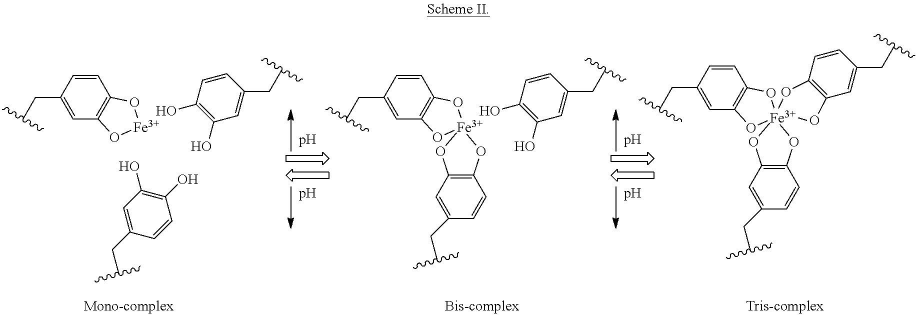

The pH required to establish the tris-catecholato-Fe³⁺ complexes will vary depending on the chemical environment of the catechol but is typically reported to be above pH 7. The solubility of Fe³⁺ is however very poor at anything but acidic pH. Therefore, no solid-state material established via tris-catecholato-Fe³⁺ cross-linking has been reported to date at the expected pH values for such complexes. If the pH is lowered to acidic pH where Fe³⁺ is more soluble, mono-catecholato-Fe³⁺ complexes are favored, and unusually high Fe:catechol ratios>>⅓ have been reported when inducing solidification. The disclosed methods avoid Fe³⁺ precipitation while establishing solid state materials from concentrated polymer solutions via tris-catecholato-Fe³⁺ cross-links at high pH.

Mussel byssal threads self-assemble in the ventral groove of the mussel foot upon secretion of pre-assembled thread materials from intracellular granules of byssal gland cells. Although the pH of the secretory granules in mussels has not been measured, given the pH values of granules from other eukaryotic secretion systems (pH 5-6) the thread materials likely undergo a significant pH jump upon release into seawater (pH about 8).

Without wishing to be bound by any particular theory, we propose that Fe3+ could be stably bound in non-cross-linking mono-dopa-Fe3+ complexes in concentrated mfp-1 solutions in intracellular granules at low pH and, following secretion, the resulting increase in pH drives a spontaneous cross-linking of the coating material via tris-dopa-Fe3+ complexes.

In one embodiment, a simple dopa-modified polyethylene glycol polymer (PEG-(N-Boc-dopa)4, abbreviated as PEG-dopa4 here, Scheme I) can be used. We first verified the stoichiometric transitions of the catechol-Fe3+ complexes expected with increasing pH by reacting dilute (0.1 wt %) PEG-dopa4 with FeCl3 in a dopa:Fe molar ratio of 3:1 (0.74×10-3 wt % Fe). We first mixed concentrated PEG-Dopa4 with FeCl3 in a dopa: Fe3+ ratio of 3:1 at pH of about 3. Upon mixing, a green colored solution instantly developed due to establishment of mono-dopa-Fe3+ complexes.

Binding Fe3+ in stable non-cross-linking mono-dopa-Fe3+ complexes allowed base addition (raising the pH) to favor the tris-dopa-Fe3+ cross-linking complexes without precipitating the Fe3+. Upon addition of 6 molar equivalents of NaOH per Fe3+, a red gel instantly formed due to establishment of tris-dopa-Fe3+ complexes. When the Fe-gels were exposed to a concentrated solution of the Fe3′ chelating agent EDTA at pH 4.7, they dissolved completely within minutes. This confirms that the redox activity of Fe3+ does not lead to oxidation of dopa resulting in covalent di-dopa cross-linking after 24 hours.

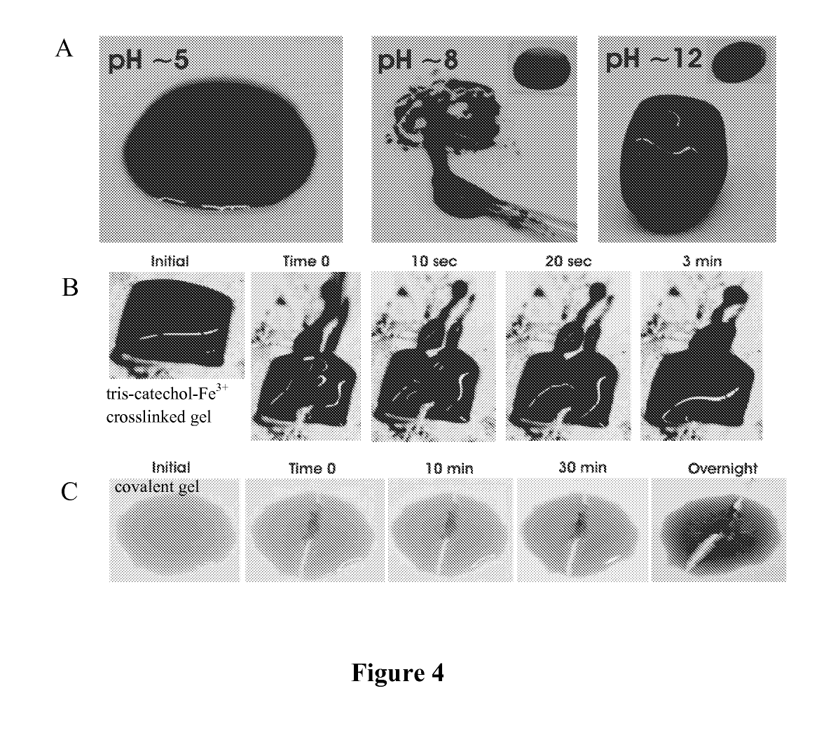

We next introduced the gel-forming pH jump in a step-wise manner. Once again, initially, dilute (0.1 wt %) PEG-dopa4 was reacted with FeCl3 in a dopa:Fe molar ratio of 3:1 (0.74×10-3 wt % Fe) and NaOH was added in small quantities, with mixing. The initially green solution turned blue and finally red as the catechol-Fe3+ stoichiometry changed from mono- to bis- to tris-, respectively. FIG. 4A shows photographs of the physical states that indicate the consistencies of the 10 wt % PEG-dopa4 gels in mono-, bis- and tris-catechol-Fe3+ complexes (dopa:Fe 3:1). In one example, the pH 5 gel was a fluid, the pH 8 gel was a tacky gel, and the pH 12 gel was a cohesive stiffer gel.

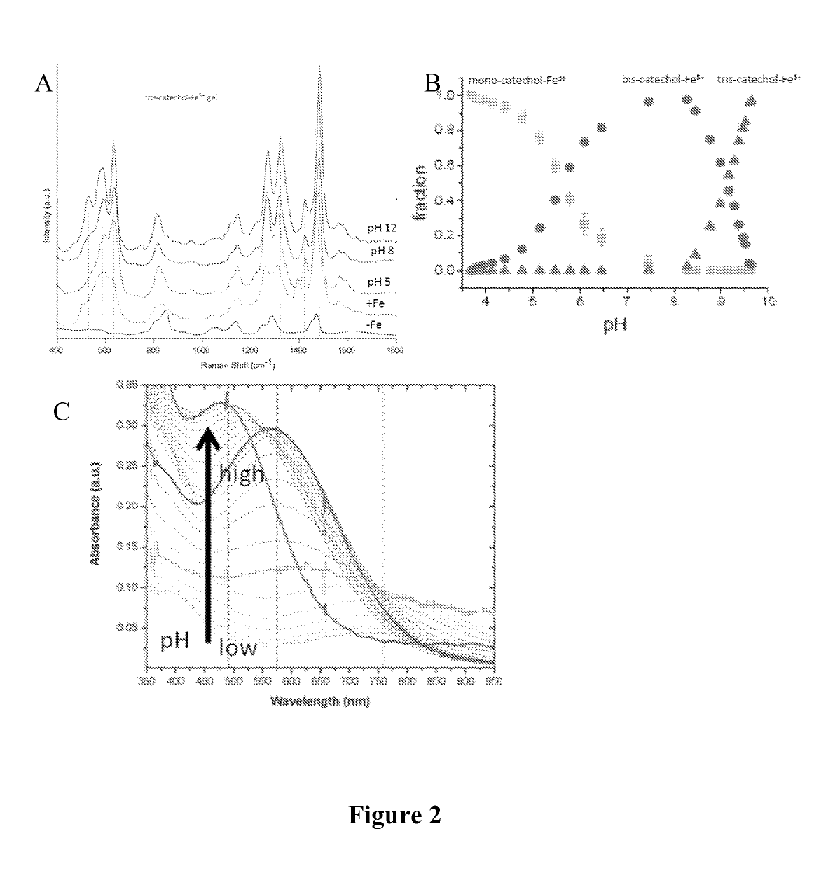

The relative fractions of the three coordination states, extracted from the experimentally measured absorbance data (see Methods for details), show that the mono-species dominated at pH<5.6, bis- at 5.6<pH<9.1 and tris- at pH>9.1. FIG. 2B shows the relative fractions of mono-, bis- and tris-catechol-Fe3+ complexes in dilute PEG-dopa4 with FeCl3 (dopa:Fe molar ratio of 3:1) as a function of pH.

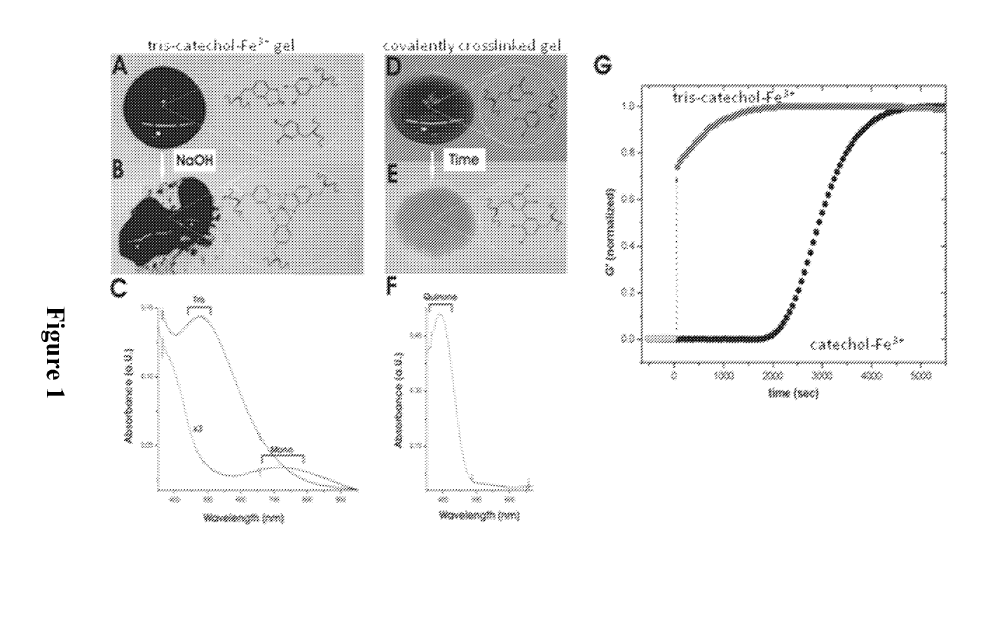

We next tested the effect of catechol-Fe3+ cross-linking on concentrated networks (10 wt % polymer, 0.074 wt % Fe, dopa:Fe 3:1) at pH about 5 (proposed pH of secretory granules), pH about 8 (pH of seawater) and pH about 12 (complete tris-catechol-Fe3+ cross-linking). Pre-binding Fe3+ in mono-catechol-Fe3+ complexes at acidic pH prevented ferric hydroxide precipitation upon raising the pH. The polymer-FeCl3 mixture remained a green/blue fluid upon raising the pH to about 5, whereas raising the pH to about 8 resulted in the instant formation of a sticky purple gel. At pH about 12 a red elastomeric gel immediately formed (FIG. 1A,B,G).

FIG. 1 shows that (FIG. 1A) 100 mg/ml PEG-dopa4 with 2.2 mg/ml FeCl3 (dopa:Fe molar ratio of 3:1) (FIG. 1B) gelled instantly when the pH was raised to ˜12 with NaOH. FIG. 1C shows the absorbance spectra of a solution of 4 mg/ml PEG-dopa4 with 88 μg/ml FeCl3 (dopa:Fe 3:1) before and after increasing pH, demonstrating the transition from mono- to tris-dopa-Fe3+ complexes with the change in pH. The absorbance of the mono-dopa-Fe3+ solution has been increased 3 times for easier peak comparison.

FIG. 1G shows the kinetics of tris-dopa-Fe3+ cross-linking-induced (and NaIO4-induced covalent cross-linking, discussed below): 100 mg/ml PEG-dopa4 with or without 2.2 mg/ml FeCl3 (dopa:Fe 3:1) was mixed with NaOH at time 0. The arrow indicates the jump in G′ after the pH increase from ˜3 to ˜12 in the PEG-dopa4+FeCl3 sample. UV-Vis absorbance spectroscopy confirmed the dominance of mono-, bis- and tris-catechol-Fe3+ complexes, in the pH about 5, about 8 and about 12 adjusted gels, respectively (FIG. 2C).

FIG. 2C shows the UV-Vis absorbance spectra of PEG-dopa4-Fe3+ solution and gels. 1 mg/ml PEG-dopa4 with 22 μg/ml FeCl3 (dopa:Fe molar ratio of 3:1) under increasing pH by titration with 1 M NaOH (dotted lines). All curves below the light grey curve are at pH<5.6, where the mono-complex dominates; all middle curves are in the range 5.6<pH<9.1, where the bis-complex dominates; all highest intensity curves around 500 nm are at pH>9.1, where the tris-complex dominates. The absorbance of gels (100 mg/ml PEG-dopa4 with 2.2 mg/ml FeCl3, dopa:Fe ratio 3:1) at pH˜5 (solid green), pH˜8 (solid blue) and pH˜12 (solid red) are shown as the bold gray lines (pH˜5 and pH˜8 have been artificially increased 1.3 and 1.2 times, respectively, while the pH˜12 gel has been decreased 0.5 times to allow easier comparison). Absorption maxima for pure mono- (˜759 nm), bis- (˜575 nm) and tris-catecholato-Fe3+ (˜492 nm) complexes are indicated with vertical dashed lines.

Raman microspectroscopy performed with a near-infrared (785 nm) laser furthermore demonstrated resonance Raman spectra characteristic of Fe3+-catechol coordination in Fe3+ gel samples as a function of pH. FIG. 2A shows the resonance Raman spectra of the gels as a function of pH. The spectra of PEG-dopa4 without (−Fe) and with (+Fe) FeCl3 (unadjusted pH˜3-4) are shown for comparison. Additionally, the spectrum from the native mussel thread cuticle is included. For each spectra, N=3.

Clear spectral differences exist between samples, particularly in the Raman band originating specifically from the chelation of the Fe3+ ion by the oxygen atoms of the catechol (470-670 cm-1). This band consists of three major peaks, which transform significantly with changing pH. The peaks at about 590 cm-1 and about 633 cm-1 are assigned to the interaction between the Fe3+ ion and the C3 and C4 oxygen atoms of the catechol, respectively, while the peak at 528 cm-1 is assigned to charge transfer (CT) interactions of the bidentate chelate. The area of the CT peak increases relative to the other two peaks upon increasing pH from about 6% at pH about 5 to about 30% at pH about 8 and almost 40% at pH about 12. This peak progression suggests an increase in bidentate complexation with increasing pH consistent with the transition from mono- to tris-coordinated Fe3+ species. Moreover, the resonance signals from the tris-catechol-Fe3+ cross-linked gels at pH about 12 and reconstituted Fe3+ mfp-1 complexes were found to be remarkably similar to the native thread cuticle.

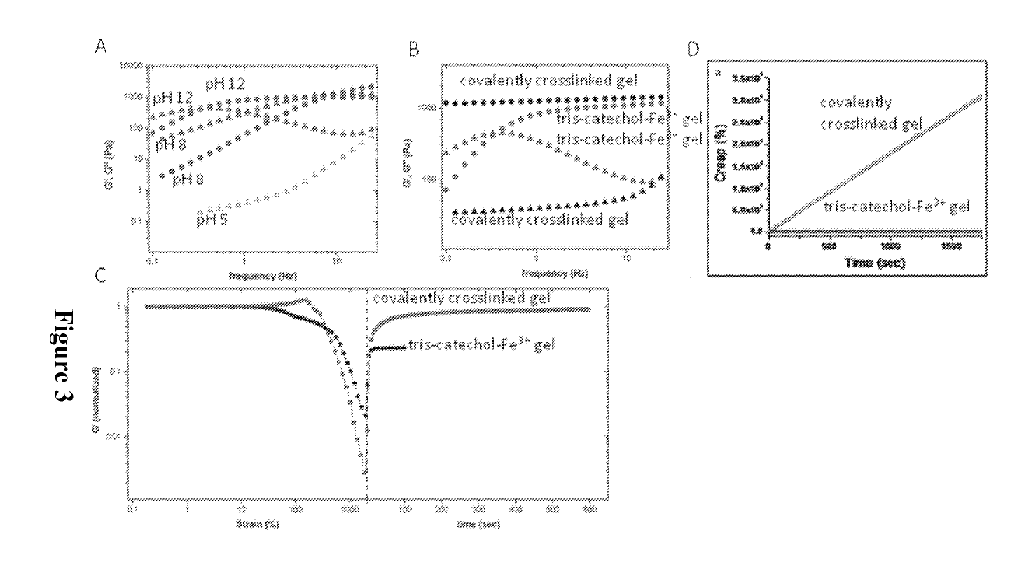

In agreement with their lack of cross-linking, the polymer-FeCl3 mixtures at pH about 5 displayed a viscous response in dynamic oscillatory rheology, whereas the bis- and tris-catechol-Fe3+ cross-linked gels at pH about 8 and pH about 12, respectively, behaved increasingly elastically (elastic modulus G′>viscous modulus G″) (FIG. 3A, which shows the results of frequency sweeps of PEG-dopa4 Fe-gels (dopa:Fe molar ratio of 3:1) adjusted to pH˜5, pH˜8 and pH˜12, storage modulus (G′, circles) and loss modulus (G″, triangles)).

For comparison, a covalently cross-linked polymer gel was prepared using NaIO4-induced oxidation of PEG-dopa4. When a tris-catechol-Fe3+ cross-linked gel and a covalent gel were exposed to a concentrated solution of the Fe3+ chelating agent EDTA at pH 4.7, only the former dissolved. This result supports the notion that the redox activity of Fe3+ does not lead to significant covalent cross-linking via oxidation of catechol within the time frame of our experiments (<24 hours) as has been reported in other systems.

When NaIO4 was used as an oxidizing agent, however, di-dopa covalent cross-linking drove gelation within about 1 hour (FIG. 1D,E,G). FIG. 1G shows the kinetics of NaIO4-induced covalent cross-linking: 100 mg/ml PEG-dopa4 without 2.2 mg/ml FeCl3 (dopa:Fe 3:1) was mixed with NaIO4 at time 0. For both gels, G′ was normalized to peak values.

FIG. 1D shows a 100 mg/ml PEG-dopa4 sample with 4.3 mg/ml NaIO4 (dopa: IO4-molar ratio of 2:1). The solution (FIG. 1E) gelled slowly over time. The visible absorption spectrum (FIG. 1F) of the solution of 4 mg/ml PEG-dopa4 with 0.172 mg/ml NaIO4 (dopa:IO4-2:1) immediately after mixing. The yellow/orange color of the solution was consistent with quinone absorbance. The pH was about 5.

The gels made using NaIO4 (hereafter called IO4-gels) behaved elastically and needed to be pre-cast before they cured because they easily fractured when handled. In contrast, the tris-dopa-Fe3+ cross-linked gels (hereafter called Fe-gels) displayed highly viscoelastic behavior when handled and could be reversibly sculpted into any shape.

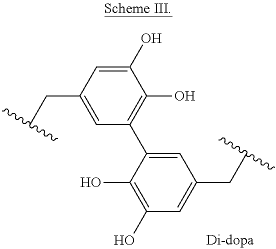 [SMILES: *Cc1cc(O)c(O)c(-c2cc(C*)cc(O)c2O)c1]

The tris-catechol-Fe³⁺ cross-linked gel was observed to dissipate >10-fold more energy (G″) than the covalent gel at low strain rates, even though the elastic moduli (G′) were similar at high strain rates (see FIG. 3B, which compares the storage and loss moduli of the tris-catechol-Fe³⁺ gel with covalently cross-linked gel, G′ and G″, circles and triangles, respectively).

Following failure induced by shear strain, tris-catechol-Fe3+ cross-linked gels recovered G′ within minutes whereas the covalently cross-linked gels remained permanently fractured, as shown qualitatively in FIG. 4B, 4C and quantitatively in FIG. 3C. FIG. 4B shows images of a tris-catechol-Fe3+ cross-linked gel (4B) and covalent gel (4C), before and after tearing material with the tip of a set of tweezers. FIG. 3C shows recovery after shear strain-induced failure of tris-catechol-Fe3+ gel and covalent gel. Gels failed under increasing oscillatory strain immediately followed by recovery under 1% strain (switch-over indicated by dashed line) while monitoring the storage modulus (G′ is normalized to values from linear regime, <60% strain, to allow easier comparison). All curves represent the means of duplicate gels.

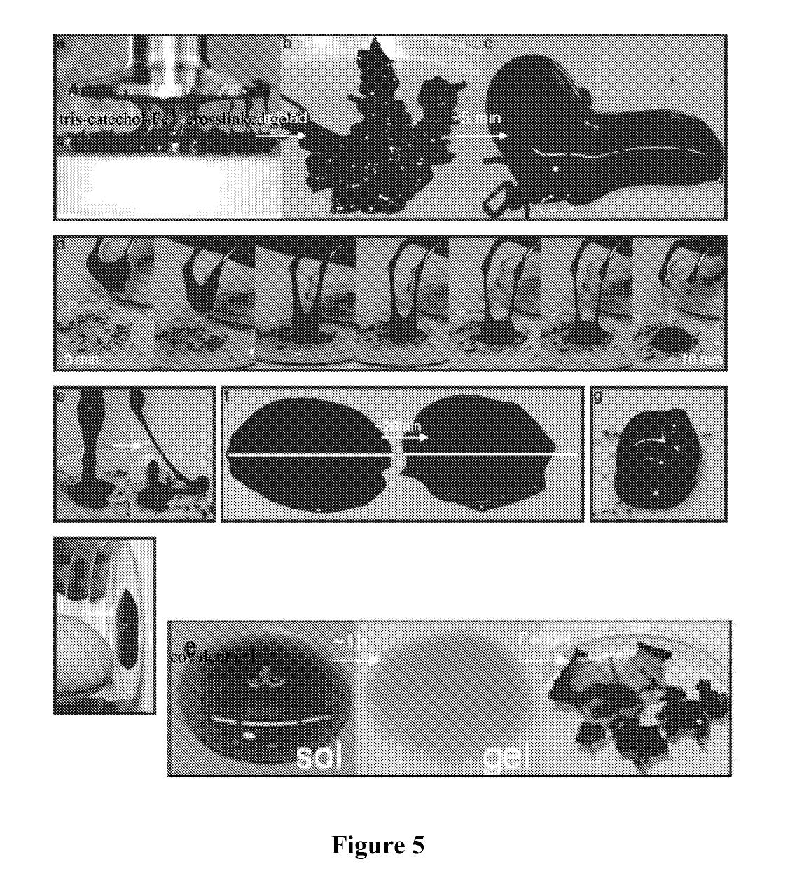

FIG. 5 illustrates the adhesive, self-healing, and viscoelastic properties of tris-catechol-Fe3+-gels in comparison with the covalent gels. Tris-catechol-Fe3+-gels: (5a) When separating the parallel plates on the rheometer, the adhesive nature of the Fe3+-gel is apparent. After unloading (5b), the Fe3+-gel self-heals in minutes (5c). (d) A Fe3+-gel stuck on a pair of tweezers slowly sinks by gravity induced flow but remains adhered to the tweezers. (e) After sticking a spatula in a Fe-gel, the gel material can easily be drawn out into cohesive strings with aspect ratios>>50. (f) Fe-gels can be squeezed flat after which the gel material will stay flat but recover ˜20% in diameter. (g) Fe-gels can be reversibly sculpted into any shape (here a parallelepiped). (h) A Fe3+-gel easily sticks to the plastic of a Petri dish (polystyrene) without observable delamination. After unloading the covalent gel (covalent gel, lower panels) from the rheometer, the gel did not self-heal.

To better characterize these contrasting properties of the gels, shear rheometry experiments were performed, the data for which are displayed in FIGS. 3A-E. As shown in FIG. 3D, a creep test using shear stress of 100 Pa shows that the Fe-gels behave as viscoelastic liquids—that is under constant shear stress they creep indefinitely at a constant rate. (FIG. 3D shows the response of Fe- and IO4-gels to a constant shear stress of 100 Pa.) In contrast, the IO4-gels display an elastic response with no creep. When testing the effect of rates of deformation under oscillating shear strains in the linear viscoelastic regime, the IO4-gels likewise respond elastically. Their properties do not change with strain rate (frequency) as seen by the constant storage (G′) and loss (G″) moduli, as shown in FIG. 3B.

In contrast, the behavior of the Fe-gels is highly dependent on strain rate. At low frequencies (slow deformation) the Fe-gels are viscous (G″>G′) whereas at higher rates of deformation the Fe-gels behave increasingly elastically; G′ crosses G″ approaching the value of the IO4-gels while G″ passes through a maximum. As shown in FIG. 3C, when both gels are strained to failure immediately followed by 1% strain at 1 Hz, the Fe-gels subsequently recover their initial storage modulus within minutes whereas the failure of the IO4-gels is irreversible. In FIG. 3C, G′ was normalized to the value before failure for both gels. A more qualitative display of this self-healing process is observed when a failed Fe-gel is unloaded from the rheometer immediately after failure (FIG. 5, tris-catechol-Fe3+ cross-linked gel, upper panel).

Without wishing to be bound by any particular theory, the observed properties of the Fe-gels and self-healing polymers support that the strength and reversibility of metal-dopa coordinate bonds observed in single molecule studies translates to strength and self-healing when used as cross-links in bulk materials. However, these properties are highly rate dependent. Since slow mutual movement of whole polymer molecules is possible due to the tris-dopa-Fe3+ cross-link reversibility, all possible elastic constraints are eventually relieved and if given enough time the Fe-gels will flow. This effect is observed under constant stress as creep, and at low frequencies in the dynamic tests where G″>G′. In contrast, in the permanently cross-linked network of the IO4-gels, the stress is balanced by the elastic forces resulting from the deformation of the covalent network, and no flow is observed. The time it takes for the Fe-gels to relax under stress is observed in the dynamic measurements as the frequency ωγ at which G′=G″ and G″ passes through a maximum. With ωγ≈0.8 Hz an estimated relaxation time γ≈1.25 s was observed. Not surprisingly, γ is about 2 orders of magnitude longer than the average life time of the metal-dopa bonds measured in single molecule studies, reflecting the contribution of polymer chain entanglements. The rate of self-healing and gel recovery is slowed even further by the complete restructuring of the polymer network necessary after failure.

At ω>ωγ, the polymer molecules in the Fe-gels do not have sufficient time to relax because the strain cycle period becomes shorter than γ. The stress in the Fe-gels is therefore carried increasingly by an elastic response of the polymer network and an increasing amount of stress is transferred to the tris-dopa-Fe3+ cross-links as the strain rate goes up. The observed G′ plateau of the Fe-gel can therefore be interpreted as a pseudo-equilibrium modulus for the tris-dopa-Fe3+ cross-linked polymer network and, given the approach to the equilibrium modulus of the IO4-gel, its strength is comparable to a covalent network at high rates of deformation.

We observed that a polymer network cross-linked with tris-catecholato-Fe3+ complexes will completely self-heal with a recovery time >γ, and the polymer network possesses the strength of a covalently cross-linked network at deformation times <γ. This is the first time that a solid state material has been established via tris-catecholato-Fe3+ cross-linking at the predicted basic pH values and Fe:catechol ratios of ⅓.

### Materials and Methods

PEG-(N-Boc-dopa)4 was obtained by preparation as disclosed by from Professor Phillip Messersmith at Northwestern University, and can be obtained according to the method previously described by Lee et al. (Lee et al. (2002) Synthesis and gelation of DOPA-Modified poly(ethylene glycol) hydrogels. Biomacromol 3: 1038-1047.

Gels. The above described PEG-(N-Boc-dopa)4 was used in a series of gel experiments. Freeze-dried aliquots of the polymer stored under argon at −20° C., were taken out 1 hour prior to use to allow equilibration to room temperature before opening the sample vial to prevent water uptake of the sample due to condensation. The powder was dissolved in unbuffered MilliQ water to a concentration of 200 mg/ml used in all gel experiments (corresponds to a dopa concentration of 80 mM). Polymer solutions were always made up fresh.

Example Gel #1 Fe-gels were established by mixing the polymer solution with ⅓ volume of 80 mM FeCl3 (Sigma, St. Louis, Mo.) to give a final FeCl3 concentration of 26.7 mM. A green color developed immediately upon mixing. Next ⅔ volume of NaOH (Sigma, St. Louis, Mo.) corresponding to 6 molar equivalents per Fe3+ was added resulting in instant gelation and red color development. The final gel concentration of PEG-(N-Boc-dopa)4 and FeCl3 was thereby 100 mg/ml and 0.4 mg/ml, respectively.

Example Gel #2 Covalently cross-linked IO4-gels were established by mixing 200 mg/ml polymer solution with an equal volume of 40 mM NaIO4, dopa: IO4-molar ratio of 2:1 (Sigma, St. Louis, Mo.) which resulted in orange color development and gelation in about 30 min. The IO4-gels need to be precast before they cure due to the elastic nature of the gel material. After gels were established they were sealed in closed containers until rheology testing to prevent dehydration (about 6 hours of cure time).

Example Gel #3 A 400 μl Fe3+-catechol cross-linked gel was made as follows. 200 μl of polymer solution was prepared by dissolving 40 mg polymer in unbuffered Milli-Q water to a starting concentration of 200 mg/ml (corresponding to a dopa concentration of 80 mM). The polymer solution was mixed with ⅙ final volume (66.7 μl) of 80 mM (13 mg/ml) FeCl3 (Sigma, St. Louis, Mo.). A green color developed immediately upon mixing. The gel was established by adding 2/6 final volume (133.3 μl) of NaOH (Sigma, St. Louis, Mo.) at a concentration adjusted to induce the desired final pH of the gel. This resulted in instant gelation and color development according to the gel pH. The gel was physically mixed until a homogenous color and physical state were established (for about 30 seconds). The rheological properties of the samples were tested immediately after mixing, except that the gels prepared for comparison to the covalently cross-linked gels were sealed in airtight containers to prevent dehydration (about 6 hours cure time). The final concentration of PEG-(N-Boc-dopa)4 in all gels was 100 mg/ml (10 wt %) with a final molar ratio of dopa to FeCl3 of 40 to 13.3 mM (3:1). This corresponds to 0.74 mg/ml (0.074 wt %) of Fe.

Samples at a final pH about 5 (predominantly mono-catecholato-Fe3+ complexes at the proposed pH of secretory granules), pH about 8 (predominantly bis-catecholato-Fe3+ cross-links at the pH of seawater) and pH about 12 (pure tris-catecholato-Fe3+ cross-links) were prepared. The pH of gels was measured using a pH-meter with a flat surface electrode designed for solids, semi-solids and liquids (FieldScout SoilStik pH Meter, Spectrum Technologies, Plainfield, Ill.).

Gels with a range of polymer wt % were prepared using N-protected PEG-(N-R-dopa)4, where R is a protecting group to measure the mechanical properties of the gels as a function of polymer wt %. The plateau modulus of G′, which provides a stiffness measurement, was measured for a series of coordinate cross-linked polymer gels with varying polymer wt %. A 0.1 wt % polymer gel, 1 mg/ml, was prepared by cross-linking with Fe3+ in a 3:1 ratio of dopa:Fe3+, and the gel yielded rheological properties corresponding to a fluid. The plateau modulus of G′ for a 10 wt % polymer, 100 mg/ml, was 20 kPa, corresponding to a nearly elastic solid. The plateau modulus of G′ for a 5 wt % polymer, 50 mg/ml, was 2 kPa, corresponding to a viscoelastic sticky adhesive. Although samples with a polymer wt % between 100 mg/ml and 500 mg/ml may be formed, the kinetics of gel formation become jammed such that bulk mixing becomes difficult and other mixing methods must be devised.

Example Gels #4,5 (Aluminum- and titanium-cross-linked gels) PEG-dopa polymers are not limited to iron as the cross-linking metal. Dopa has high affinities for other metals. Ti3+ and Al3+ substituted for Fe3+ result in the formation of gels with different visco-elastic properties.

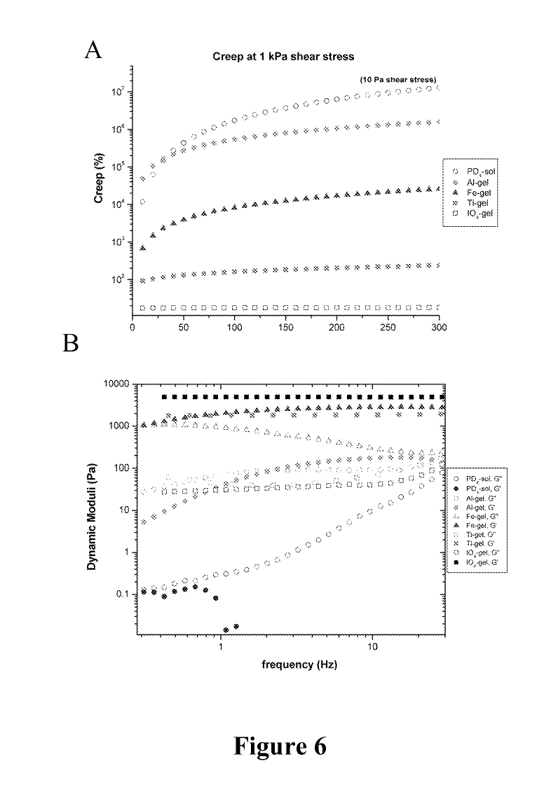

The same protocol for formation of Fe3+-catechol cross-linked PEG-dopa4 gels was used, substituting FeCl3 with either TiCl3 or AlCl3 (Sigma, St. Louis, Mo.) followed by addition of 6 molar equivalents of NaOH to induce cross-linking. Cross-linking with Al3+ produced a more viscous gel similar to jelly, whereas cross-linking with Ti3+ produced a stiffer gel similar to rubber bands. FIG. 6A shows a creep measurement performed by applying a shear stress of 1 kPa (except for polymer solutions, to which were applied only 10 Pa shear stress) and measuring the strain as described for FIG. 3D. The resistance to shear as a function of time correlated with the increasing elastic properties of the gels according to PEG4-Dopa gel<Al3+-gel<Fe3+-gel<Ti3+-gel<IO4-gel. Frequency sweep measurements, shown in FIG. 6B, were performed and a plot of the dynamic modulus as a function of frequency shows the transition from viscous to elastic gel properties going from polymer<Al<Fe<Ti<IO4.

Example Gel #6 Freeze-dried aliquots of PEG-(N-Boc-dopa)4 stored under argon at −20° C., were taken out 1 hour prior to use to allow equilibration to room temperature before opening the sample vial to prevent water uptake of the sample due to condensation. The powder was dissolved in unbuffered milliQ water to a concentration of 200 mg/ml (corresponding to a dopa concentration of 80 mM). The polymer solution was mixed with ⅓ volume of 80 mM FeCl3 (Sigma, St. Louis, Mo.) to give a final FeCl3 concentration of 26.7 mM. A green color developed immediately upon mixing, however, no gel was observed to form. The rheological properties of this gel are discussed below in the context of FIG. 3A. The physical properties of this gel are shown in FIG. 4A, left.

### Rheology of Gels

The mechanical properties of the gels were tested using a rheometer (Anton Paar, Ashland, Va.) with parallel plate geometry (25 mm diameter rotating top plate). All tests were done at 20° C. immediately after transferring the gel sample from a closed container onto the sample stage. The following mechanical tests were set-up within 5 minutes, so any water loss during testing was negligible. In creep tests a shear stress of 100 Pa was applied and held constant while measuring the resulting shear strain of the gels as a function of time.

Oscillatory shear test of gels were performed at constant 10 mrad strain (about 20% strain, linear viscoelastic regime 0—about 60% strain) strain while measuring storage modulus (G′) and loss modulus (G″) as a function of frequency. Recovery tests were performed by straining each gel to failure under increasing oscillations to 1000 mrad immediately followed by linear conditions (1% strain, 1 Hz) while monitoring the recovery of the storage modulus (G′).

For both types of gels, G′ was normalized to values in the linear regime to allow easier comparison. Water loss during testing was negligible due to typical gap distances between parallel plates of about 0.4 mm and typical test time of <30 min. During longer measurements of the rates of cross-linking, the tests were performed in an enclosed cell as a precaution to avoid sample dehydration.

The mechanical properties of catechol-Fe3+ polymer networks can be easily controlled since the networks behave according to the average lifetime of their catechol-Fe3+ cross-links set by the final pH. The pH-induced shifts of the frequency at maximum viscous dissipation (ƒmax) observed in shear rheometry demonstrate this effect (see FIG. 3A). As the pH of cross-linking increases from about 8 to about 12, ƒmax shifts from ≈14.3 Hz (mean, s.e. 0.5, N=4) to ≈0.39 Hz (mean, s.e. 0.01, N=6) in agreement with a decrease in cross-link dissociation rate. Our data suggest average relaxation times τ(1/ƒmax) of τ≈0.070 s and τ≈2.56 s, respectively, for bis- and tris-catechol-Fe3+ cross-linked networks. The near covalent stiffness (G′) of tris-catechol-Fe3+ cross-linked networks at high strain rates (see FIG. 3B) supports the hypothesis that catecholato-Fe3+ coordinate bonds can provide significant strength to bulk materials despite their transient nature, given that the pH is high enough to ensure cross-link stability on relevant timescales. Additionally, the tris-catechol-Fe3+ cross-linked gels reestablish their stiffness and cohesiveness within minutes after failure (see FIG. 3C) through restoration of broken catecholato-Fe3+ cross-links. Polymer size, cross-link density, and Fe:dopa ratio can be varied to vary the relaxation and self-healing time of catecholato-Fe3+ cross-linked polymer networks. In addition, the microenvironment may be tuned, for example, by varying the polymer backbone by adding pendant functional groups or copolymers along the PEG backbone.

### Absorbance Spectroscopy

The dopa-Fe3+ cross-linking stoichiometry and the dopa oxidation was observed using a UV-visible light spectrometer (Perkin Elmer, Waltham, Mass.) using a quartz cuvette with a path length of 1 cm.

Spectral changes of solutions of 1 mg/ml PEG-dopa4 (0.4 mM dopa) with 22 μg/ml (0.13 mM) FeCl3 (dopa:Fe molar ratio of 3:1) were followed while increasing pH with 1 M NaOH up to a final pH about 10. The absorbance of 4 mg/ml PEG-dopa4 (1.6 mM dopa) with 4.3 mg/ml (0.8 mM) NaIO4 (dopa: IO4-molar ratio of 2:1) was monitored immediately following mixing. Furthermore, the absorbance of 4 mg/ml PEG-dopa4 with 88 μg/ml FeCl3 (dopa:Fe 3:1) before and after increasing pH from about 3 to about 9 was recorded for comparison with the NaIO4 induced spectral changes. Absorbance of gels was measured holding the gel between two cover slips and placing them directly in the light path of the spectrophotometer.

To extract the relative abundance of the three dopa-Fe3+ cross-linking species, the UV/VIS absorbance data from FIG. 2C were fitted to peak functions in an iterative manner to obtain spectra of the three species that could be used to fit all spectra. For quantification, only the peaks above 400 nm were used since the data below this range were too severely affected by overlap; the main absorption above 400 nm of the mono species was found to be a doublet at 406 and 759 nm, the dimer had a peak at 575 nm while the trimer had a peak at 492 nm. These values agree with spectra reported in the literature for similar species. The areas of the peaks were then normalized to the maximum value for each peak. No constraints on the sum of the fractions were imposed during the fitting procedure. The largest deviation from unity was 3.4 estimated standard deviations (esd) with an average of 1.6 esd indicating that the fits successfully distributed the intensity into the respective contributions. The data shown in 2B have been normalized so that the sum of the mole fractions is equal to one.

### Resonance Raman Spectroscopy

For Raman spectroscopic studies, a continuous laser beam was focused on a sample through a confocal Raman microscope (CRM200, WITec, Ulm, Germany) equipped with a piezo-scanner (P-500, Physik Instrumente, Karlsruhe, Germany). The diode-pumped 785 nm near infra-red (NIR) laser excitation (Toptica Photonics AG, Graefelfing, Germany) was used in combination with a 20× microscope objective (Nikon, NA=0.4). The spectra were acquired using an air-cooled CCD (DU401A-DR-DD, Andor, Belfast, North Ireland) behind a grating (300 g mm-1) spectrograph (Acton, Princeton Instruments Inc., Trenton, N.J., USA) with a spectral resolution of 6 cm-1. Because the samples were sensitive to burning by the laser beam, a laser power of between 10-20 mW, combined with a short integration time of 0.2 s was used for all measurements. The ScanCtrlSpectroscopyPlus software (version 1.38, Witec) was used for measurement setup and spectral processing. Each collected spectra consisted of 60 accumulations of a 0.2 s integration time. For each sample, three spectra were collected from different regions and averaged. Averaged spectra were smoothed with a Savitzky-Golay smoothing filter, and a 2nd order polynomial background was subtracted from the smoothed spectra.

Various modifications and variations can be made to the compositions and methods described herein. Other aspects of the compositions and methods described herein will be apparent from consideration of the specification and practice of the compositions and methods disclosed herein. It is intended that the specification and examples be considered as exemplary and within the scope of the claims that follow.

1. A method of forming a self-healing polymer, comprising:
a. providing a polymer comprising at least two catechol groups;
b. contacting the polymer with a solution comprising a soluble metal of formula Mⁿ⁺ at a first pH value, where n is an integer from 1 to 9;
c. contacting the polymer metal solution with another solution to achieve a second pH value, wherein the second pH value is higher than the first pH value.

2. The method of claim 1, wherein the metal is selected from iron, aluminum, titanium, vanadium, manganese, copper, chromium, magnesium, calcium, and silicon.

3. The method according to claim 1, wherein the polymer backbone is selected from polyethylene glycol, polyacrylate, polymethacrylate, polystyrene, polyvinyl polymer, and polypeptide.

4. The method according to claim 1, wherein the metal is coordinated to at least two catechol groups at the second pH value.

5. The method according to claim 1, wherein the metal is coordinated to three catechol groups at the second pH value.

6. The method according to claim 1, further comprising a second monomer.

7. The method according to claim 1, wherein the second monomer comprises a catechol group.

8. The method according to claim 1, wherein n is 3.

9. The method according to claim 1, wherein the metal is iron and monomer is dopa.

10. The method according to claim 1, wherein the catechol to metal ratio is no less than 3:1.

11. The method according to claim 1, wherein the catechol to metal ratio is about 3:1.

12. The method according to claim 1, wherein the polymer is a synthetic polymer.

13. The method according to claim 1, wherein the polymer is a non-peptide polymer.

14. The method according to claim 1, wherein the polymer comprises a backbone of polyethylene glycol.

15. A polymer composition prepared by the method of claim 1.

16. A method of forming a self-healing polymer, comprising:
a. providing a polymer comprising at least two catechol groups, wherein the polymer backbone is selected from polyethylene glycol, polyacrylate, polymethacrylate, polystyrene, polyvinyl polymer, and polypeptide;
b. contacting the polymer with a solution comprising a soluble metal of formula Mⁿ⁺ at a first pH value, where n is an integer from 1 to 9 and wherein the metal is selected from iron, aluminum, titanium, vanadium, manganese, copper, chromium, magnesium, calcium, and silicon;
c. contacting the polymer metal solution with another solution to achieve a second pH value, wherein the second pH value is higher than the first pH value.

17. The method according to claim 16, further comprising a second monomer.

18. The method according to claim 17, wherein the second monomer comprises a catechol group.

19. The method according to claim 16, wherein the catechol to metal ratio is about 3:1.

20. The method according to claim 16, wherein the polymer is a synthetic polymer.
